(19) United States
(12) Patent Application Publication
(10) Pub. No.: US 2001/0004259 A1
(43) Pub. Date: Jun. 21, 2001

(54) Method for a real time audio assisted instruction

(76) Inventor: Jack Chen, Hsinchu (TW)

Correspondence Address: BIRCH, STEWART, KOLASCH & BIRCH, LLP, P.O. Box 747, Falls Church, VA, 22040-0747, US

(21) Appl. No.: 09/735,494

(22) Filed: Dec. 14, 2000

(30) Foreign Application Priority Data
Dec. 16, 1999 (TW) 88122158

(51) Int. Cl. G06F 3/00

(52) U.S. Cl. 345/418

(57) ABSTRACT

A correlative real-time audio assisted instructional method is applicable to an object (such as book or object of daily lives) for learning, It utilizes a label and a recognition device, The label contains index of sound information. The recognition device can read the label and generate sound information to achieve a real-time instruction. Sound information, such as question or answer of objects or music, are correlatively singly arranged or linked into a series for user to use the recognition device tracing the labels and learn. This multiple layer, correlative real-time instruction method will increase the fun and efficiency of learning, especially for little children.

### BACKGROUND OF THE INVENTION

1. Field of Invention

The present invention generally relates to method for achieving an audio assisted instruction, and more particularly relates to a method for achieving a real time audio assisted instructions which utilizes a label and an audible instructional unit. The label is attached to an object to be learned. The instructional unit can scan the label and generate audible information for a real time instruction.

2. Related Art

Conventional instructional materials are mainly books or pictorial media having words or pictures printed on papers. This kind of instructional material can help those students or adults that have been familiar with fundamental knowledge and capable of recognizing words or characters. The efficiency of learning mainly depends on attitude and capability of die learner, and less depends on the contents of die materials. But, for those kids before school age or persons who know less or none of the words, the books or pictorial materials can help a few. They need helps of parents or other instructors, or also assistant apparatus, such as audio or video instructional materials. The most popular assistant materials are based on audio functions, for example, audio and videocassettes.

Some audio Assisted materials include books as major materials and cassettes as supplementary materials. The cassettes require a player or recorder to play, During playing, the learner has to catch up with tire successive program, and is hard to pass over specific portions if desired. It is also difficult to repeat with a specific portion of the program if the player is not specially equipped with the function. Therefore, the efficiency and function of the common audible instructional materials are not good enough. Even the videocassettes with images still have the same problem.

Recently, computerized multimedia instructional materials utilize the audio and video processing capabilities of computer and provide an interactive learning environment for the users. Though the computerized multimedia instruction is interesting and versatile, it requires the computer facilities that are rather expensive. To operate the computer also requires skills that are not easy for small children. Therefore: it is not always easy and suitable for everybody.

### SUMMARY OF THE INVENTION

It is therefore an object of the present invention to provide a method for achieving an audio assisted fuction, which can overcome the disadvantages of conventional method of text and picture instruction.

Another object of the present invention is to solve problems of conventional method .with audible books or computerized multimedia materials, and provide a method for a real-time responsive learning assistance which can be freely applied to read materials at anytime from any entry without being limited of successive reading like the method of a cassette.

A further object of the present invention is to provide a method for an audio assisted instruction, which is suitable for children before school age,

To achieve the aforesaid object, a method for achieving an audio assisted instruction includes steps of: establishing an sound database including sound information of verbal questions, answers, music or a series of correlative sound information; preparing a label attachable to the object to be learned and carrying index of sound information correlative to the audio database; and proving a recognition device for reading the label, fetching the correlative sound information and generating sound for a real time instruction.

An embodiment of the instruction method according to the present invention is to allocate a label, containing e.g., a barcode, on the object to be learned, and store sound information correlative to content of the label in a label-recognition device. Therefore, when an user using the recognition device to scan the label, the device will recognize the content of the label, fetch the correlative sound information and play it, and achieve a real-time audio assisted instruction.

Further scope of applicability of the present invention will become apparent from the detailed description given hereinafter however, it should be understood that the detailed S description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention Will become more fully understood from the detailed description given hereinbelow illustration only, and thus are not limitative of the present invention, and wherein:

FIG. 1 is a block diagram showing a composition of the present invention,

FIG. 2A is a first embodiment of a recognition device applied in the present invention;

FIG. 2B is a second embodiment of a recognition device applied in the present invention;

FIG. 3A is a diagram showing correlation of sound information and label information;

FIG. 3B is a diagram showing relationship of information tables for sound information.

FIG. 3C is a diagram showing a series of correlative sound information;

FIG. 4 is a major flowchart of the present invention,

FIG. 5 is a flowchart of a first embodiment of the present invention;

FIG. 6 is a flowchart of a second embodiment of the present invention;

FIG. 7 is a flowchart of a third embodiment of the present invention;

FIG. 8 is a flowchart of a fourth embodiment of the present invention;

FIG. 9 shows a example of application of the present invention in which a book is used; said

FIG. 10 shows another example of application of the present invention in which an object is to be learned.

### DETAILED DESCRIPTION OF THE INVENTION

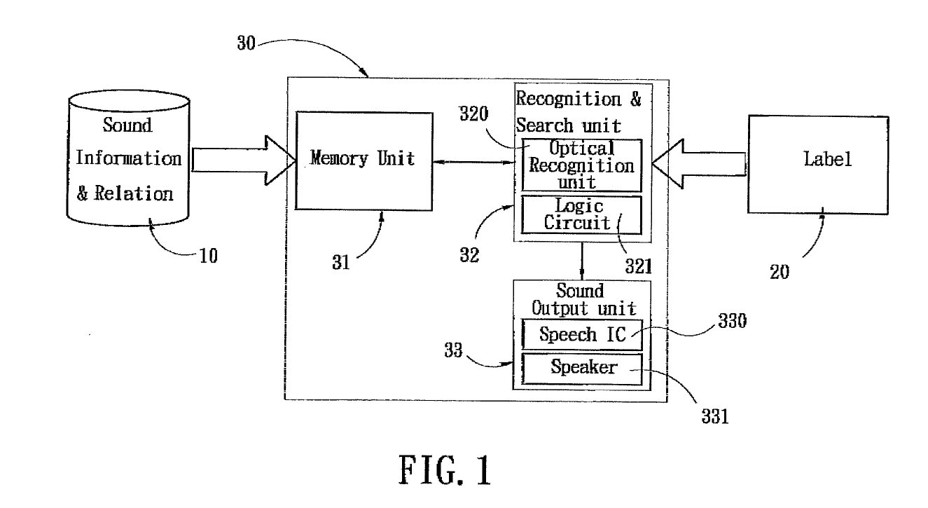

As shown in FIG. 1, a system to accomplish an audio assisted instruction according to the present invention includes a sound database 10 containing sound information, a label 20 carrying index of relative sound information, and a recognition device 30 for recognizing the label and generating correspondent sounds.

A method for achieving an audio assisted instruction according to the present invention includes the following steps:

1. Preparing a label 20 attachable to the object to be learned and carrying index of sound information;

2. Establishing a sound database including sound correlative to the index on the label;

3. Providing a memory unit 31 for storing the sound database and the correlation of the index and the sound information;

4. Providing a recognition and search unit 32 for recognizing the content of the label, and fetching correlative sound information from the sound database 10 by the index, and

5. Proving a sound output unit 33 for playing the fetched sound.

The label 10 is preferably made with barcodes. The barcodes are printed directly on the object to be learned, or on a sticker to be adhered to the object. Of course, laser-printed stickers can also be used.

The recognition device 30 includes functions of optical recognition and logic operation so as to recognize the label 20, search the correlative sound information from the database 10 by the index, and play the correlative sound information. In order to accomplish these functions, the recognition device 30 includes at least, a memory unit 31, a recognition and search unit 32, and an audio output unit 33. The memory unit 31 is a module of memory chips for storing digitized sound information. The sound information is stored in the sound database 10 correlatively to the index printed on the label 10. The recognition and search unit 32 includes an optical recognition with 320 and a logic circuit 321 for recognizing the label 20, and searching the correlative sound information from the database of memory unit 31. The audio output unit 33 includes a speech IC 330 and a speaker 331 for playing the correlative sound information fetched by the recognition and search unit 32. The sound can also be played through an unshown external speaker or an earphone via a connector.

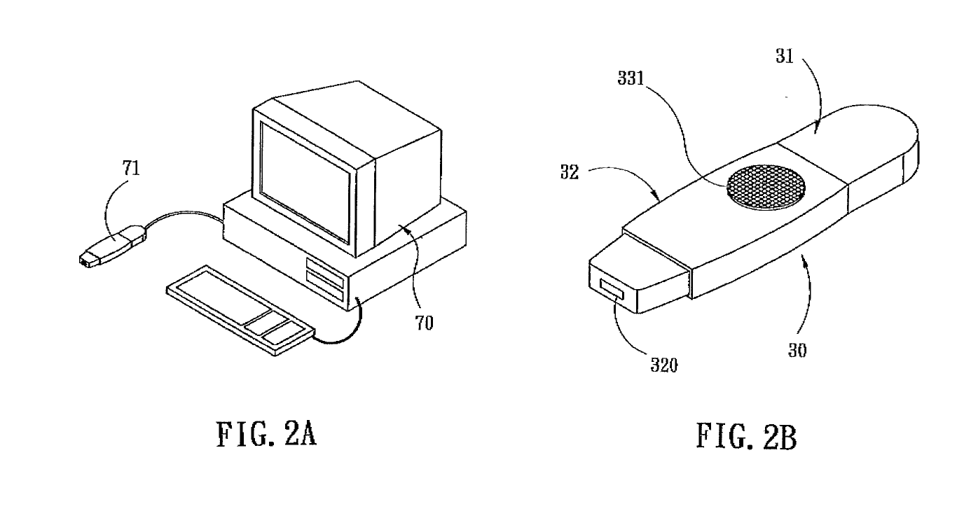

As shown in FIG. 2A, the recognition device 30 can be a computer 70, such as a personal computer, a laptop computer or a personal data assistant, equipped with memory device and barcode scanner 71 Another embodiment, shown in FIG. 23, is a pen-shaped handy device for easier operation and carrying. The recognition device 30 has an optical recognition unit 320 in the front end, a recognition and search unit 32 and speaker 331 in the middle portion, and a replaceable memory unit 31 at the rear end.

As shown in FIG, 3A, a Sound Information Table (table 2) includes a plurality of records having correlative fields of “Sound No.” and “Sound Information”. Each Sound No. relates to a correspondent Sound Information. While, a Label Information Table includes a plurality of records having correlative fields of “Label ID” and “Sound No.”. The Label Information Table represents those labels 20 to be scanned. When a label 20 being scanned by the recognition device 30, idle sound No. relative to the label is recognized, so that the correlative sound information can be fetched according to the correlation.

In the embodiments of the present invention, the labels 20 can be classified into three categories. Question Label relating to sound of question; Answer Label relating to sound of answer: and Description Label relating to sound of descriptive speech or music.

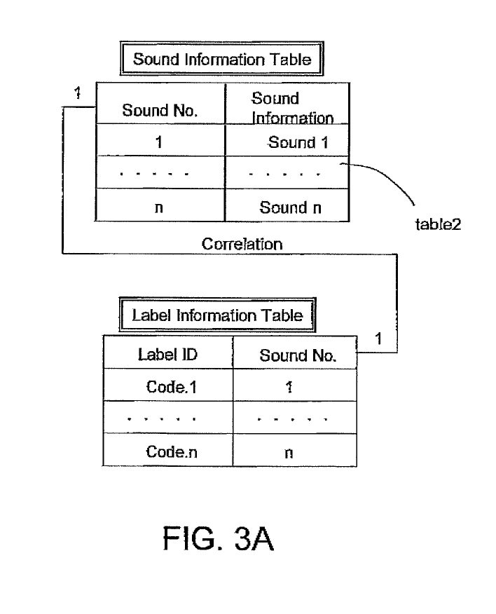

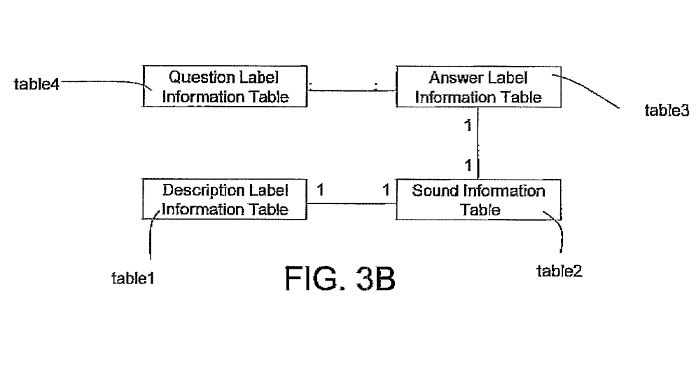

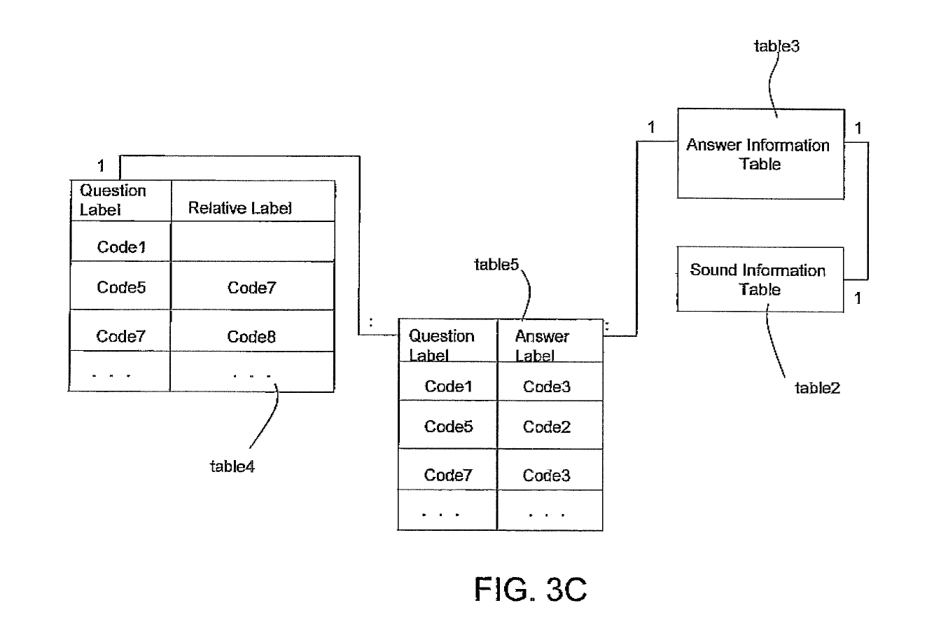

The relationship of the Label Information Table to the Sound Information Table (table 2) is shown in FIG. 3B. Generally, records in the Descriptive Label Information Table (table 1) are one-to-one correlative to the records of Sound Information Table (table 2). Records in the Answer Label Information Table (table 3) are also one-to-one correlative to the records of Sound Information Table (table 2).

While, the Question Label Information Table (table 4) is multiple-to-multiple correlative to the Answer Label Information Table (table 3), since a question may have several correct answers. Also, an answer may be applicable to more than one question.

In preferred embodiments, an instructional topic can be composed of a single or a series of correlative labels 20, for example, a series of correlative questions and answers, So, the user can use recognition device 30 to trace the correlation of labels 20, obtain the sound information and attain a multi-layer correlative audio assisted instruction. An example of correlative labels is shown in FIG. 3C. A series of question labels 20 is registered in the Question Label Information Table (table 4) in which the field “Question Label” contains question label IDs and the field “Relative Label” contains the question IDs relative to the former questions. An intermediate table (table 5), containing Question Label as primary key, and Answer Label as foreign key, is used to register the multiple-to-multiple correlation with table 3. Therefore, when the user giving a, correct answer to a question, the recognition device 30 will find out the next question, if any, according to the Relative Label of table 4, and continue the next correlative instruction till end of the series of correlative labels.

By using the labels 20 located on objects and the recognition device 30 to read the labels 20, the user can obtain the audio instructions. The sound information can be names of objects, questions, knowledge descriptions or music. The objects can be books, magazines or any objects in daily lives. As the recognition device 30 providing sound information correlative to the scanned label 20, even those children before school age can obtain themselves the instruction without any help of parents, and learn easily with names of objects or relative knowledge.

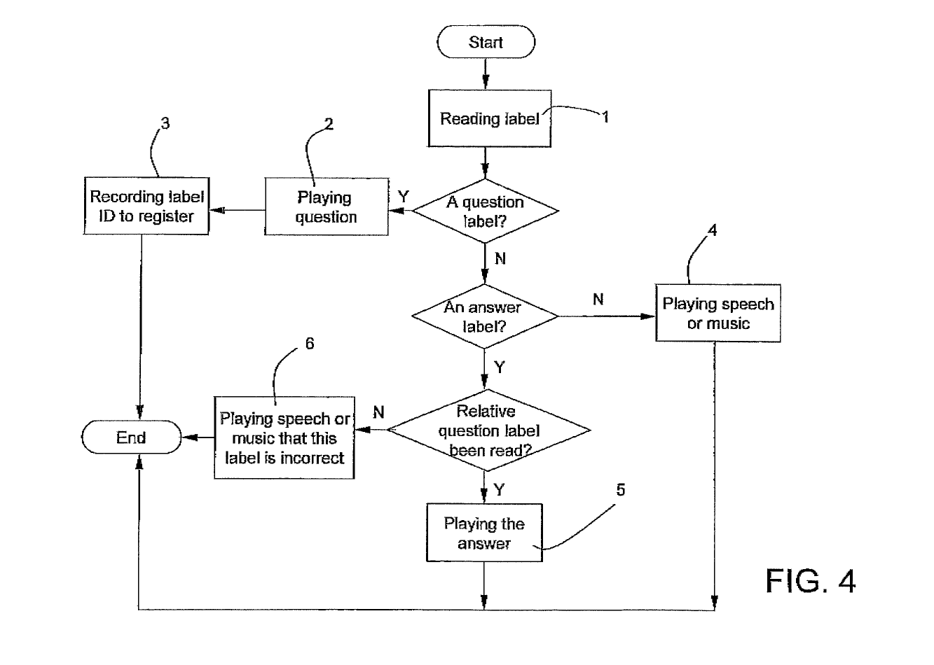

A flowchart of an embodiment of the present invention is shown in FIG. 4. The operation process of the recognition device 30 includes the following steps,

1. Reading the label 20 located on the object;

2. Checking if the label 20 is a question label, ten playing the question or music; or, go to step 4;

3. Stacking the label ID into a register for recording the scanning history, and ending the process;

4. If the label 20 is not an answer label, then playing the speech description or music, and ending the process; or, continuing the next step;

5. Checking the register if the last label is a correlative question, label of the current label, then playing the sound information (answer of the question) of the current label 20, and ending the process; or, continuing the next step;

6. Playing a speech or music representing that the current label is incorrect, for example, “You haven't read the question of this answer,”, and ending the process.

Embodiments of the correlative instruction according to the present invention will be described as follows.

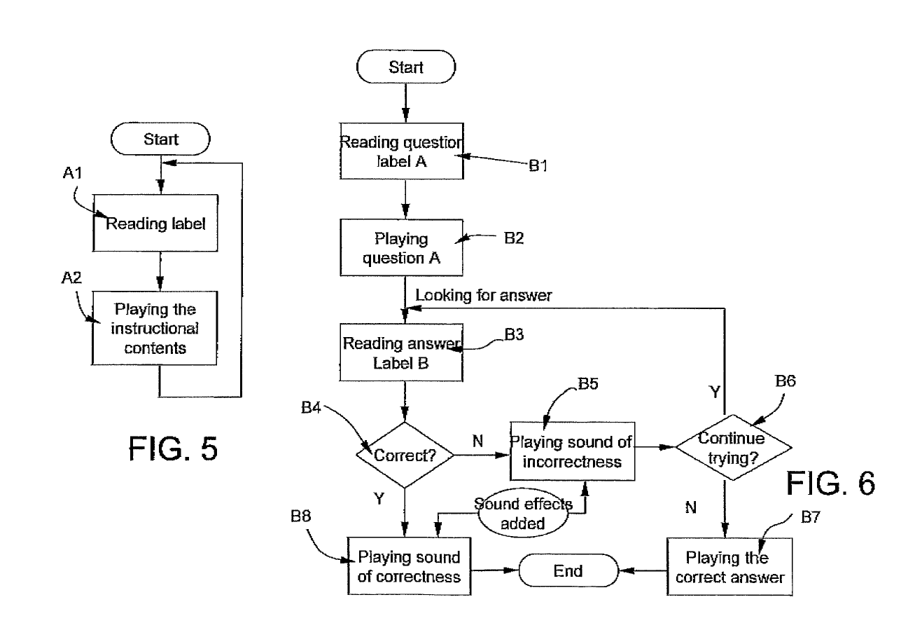

A first embodiment, as shown in FIG. 5, is based on the correlation of aforesaid table 1 and table 2 for providing a real-time audio assisted instruction. The process steps are:

A1) the recognition device 30 reading and recognizing the label 20 located on an object;

A2) playing the sound information relative to the recognized label 20.

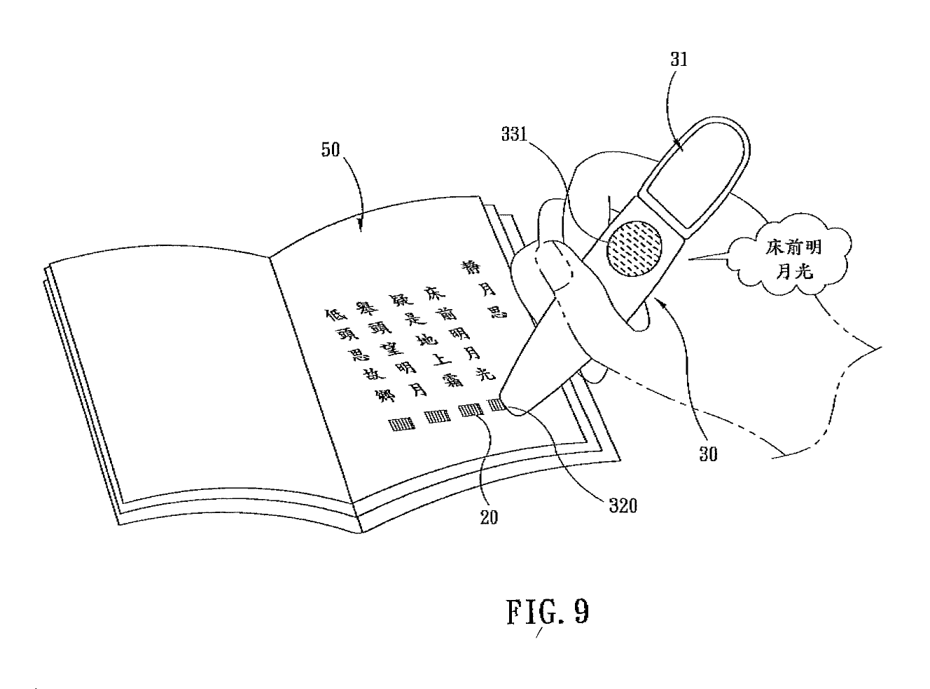

An example is shown in FIG. 9. The object to be learned is a Chinese poetry collection 50. Under each line of text, a label 20 containing index for speech reading or descriptive instruction is printed. In the recognition device 30, sound information data correspondent to the label 20 is stored. Therefore, when tire user uses the recognition device 30 with a label 20, the correspondent speech or other audible instructions will be generated through the memory unit 31, the recognition and search unit 32 and the audio output unit 33. As for the location aid number of the labels 20, they can be suitably designed to meet requirements of the instructional purpose.

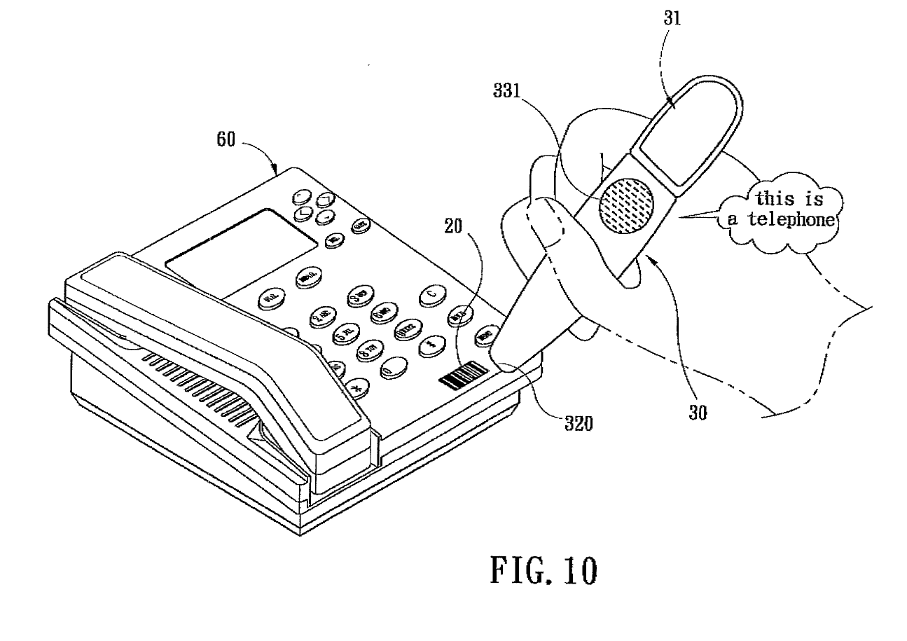

Another example is shown in FIG. 10, The object to be learned is an object of daily lives, such as a telephone 60. A label 20 is attached to the object 60. So, when a child using the recognition device 30 to read the label 20, the recognition device 30 will generate a sound, like “This is a telephone.” or further information about the telephone, to instruct the child.

Further referring to FIG. 6, a second embodiment of the present invention, a question and answer instructional process is shown. The process steps are,

B1) Reading a question label A, for example, a label with ID of Code 1 as shown in FIG. 3C;

B2) Playing the sound information correlative to the label A, for example, “Find out the satellite of earth”;

B3) Reading an answer label B, for example, a label with ID of Code 3 as shown in FIG. 3C;

B4) Checking if the scanned label is the correct answer label, then go to step 8-8; otherwise, continuing next step,

B5) Playing a sound indicating incorrectness, such as “You got the wrong answer.”, or playing a suitable music;

B6) Asking the user whether to try again by reading a label representing “Yes” or “No”, or directly getting input from a key provided on the recognition device 30. Returning to step B3 if “Yes”, and continuing next step if “No”;

B7) Playing pound information of correct answer, and ending the question; and

B8) Playing sound information indicating correctness, such as “You are good.”, or repeating the correct answer, then ending the question.

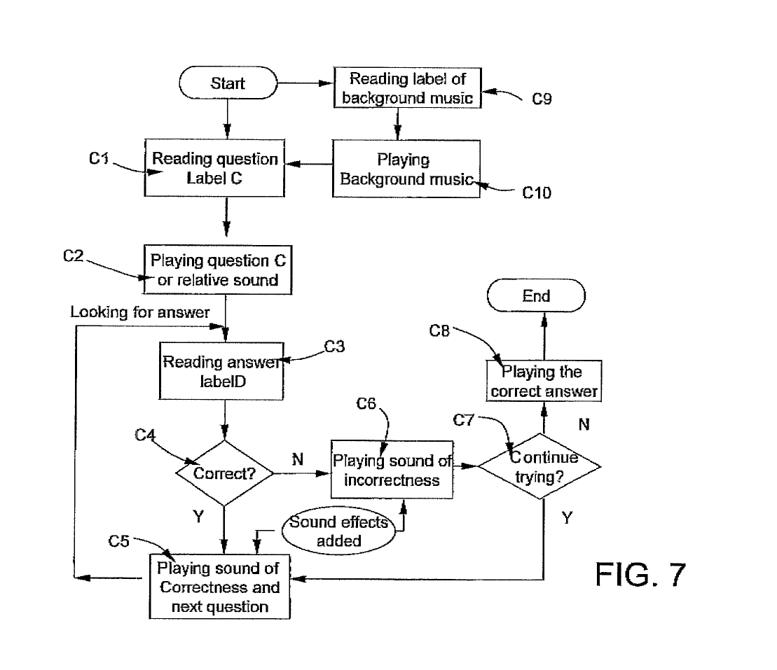

FIG. 7 shows a third embodiment of the present invention in which a series of correlative labels used for a multiple layer instruction is illustrated. The process steps are

C1) Reading a question label C, for example, a label with ID of Code 5 as shown in FIG. 3C;

C2) Playing the question, such as “Which one is the only planet in the solar system that having living beings”;

C3) Reading an answer label D, for example, a label with ID of Code 2 as shown in FIG. 3C;

C4) Checking if the scanned label is the correct answer label, then continuing next step; otherwise, go to step C6;

C5) Playing sound indicating correctness and further a relative question, as shown in FIG. 3C, a relative label with ID of Code 7, “Which one is the satellite of earth”, then

C6) Playing sound indicating incorrectness, such as “Sorry”;

C7) Asking the user whether to try again by reading a label representing “Yes” or “No”, or directly getting input from a key provided on die recognition device 30. Returning to step C5 if “Yes”, and continuing next step if “No”;

C8) Playing sound information of correct answer, and ending flee question.

Also, in step C5 or C6, a suitable sound relative to the correctness or incorrectness can be added for enhancing the fun of learning.

As described above, the label 20 can represent a question, a description or an answer. And, different categories of labels are registered into different (e.g., Question, Answer and Description) information Tables in the sound database 10. Different questions may have a same answer, for example, “moon” is the correct answer for both questions of step B1 in FIG. 6 and step C5 in FIG. 7. Therefore, the correlation shown in FIG. 3B or 3C will indicate a same ID “Code 3” as their answers, and, the same label can be repeatedly used.

The sound information stored in the sound database 10 is not limited to verbal sound of answer or question, but possible of music or others. The sound information therefore can be classified as “Questions”, “Music”, “Sound Effects”, and so on. Since sounds can be overlapped, the user can start music by reading a specific label 20 with the recognition device 30. For example, as shown in FIG. 7, the user can start a background music (as in step C10 of FIG. 7) by reading any label of music category with the recognition device 30 (as in step C9 of FIG. 7). Another case is to learn nature sounds. The user can use the recognition device 30 to read a plurality of labels that correlate to kinds of nature sounds, such as sound of raining.

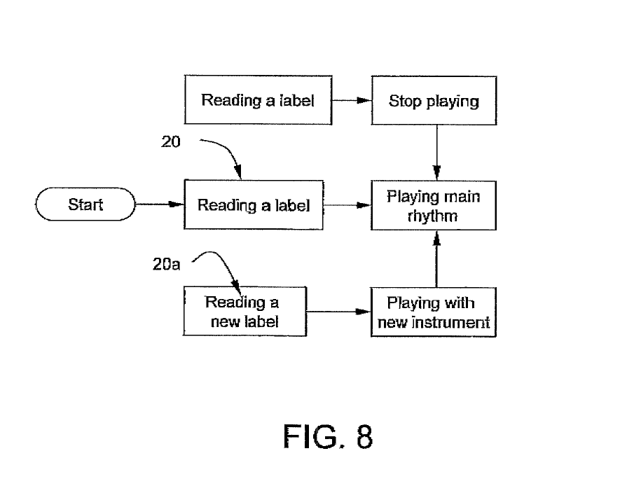

Further, When sound information stored in the sound database 10 being playing, some sound effects may also be provided, as shown in FIG. 6, for enhancing the audio effects, FIG. 8 shows another example of overlapping sounds to achieve a multiple layer instruction. When recognition device 30 reading a label, a main rhythm by a single instrument is played. After another label 20a being read, sound of a new instrument is added into the main rhythm. In the same ways other labels can be read to further add instrument into the music, or remove it, so as to help learning of musical instruments.

In conclusion, the instructional method of present invention is to utilize labels 20 as indexes of sound information to be learned. A recognition device 30 is used to read the labels 20, fetch the correlative sound information stored in a sound database 10, and play the sounds. By correlation of a label to a sound, or also a serial relationship of a plurality of labels, a single or multiple layers of sound can be obtained for a versatile audio assisted instruction. The advantages of the present invention are as follows.

1. It provides a real-time audible instruction to die user freely and promptly from a designated position, without the limitation that a tape has;

2. Any object or printed material can be the medium or object for learning;

3. The instructional contents are versatile and correlative;

4. It is most suitable for children before school age that they can learn without help of parents.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A correlative real-time audio assisted instructional method applicable to an object for learning, comprising steps of:
preparing a label attachable to said object and carrying index of sound information;
establishing a sound database including sound correlative to said index on said label;
providing a memory unit for storing said sound database and correlation of said index and said sound information;
providing a recognition and search unit for recognizing said label, and fetching correlative sound information from said sound database by said index; and
proving a sound output unit for playing sound information.

2. A correlative real-time audio assisted instructional method according to claim 1 wherein said label contains a barcode.

3. A correlative real-time audio assisted instructional method according to claim 1 wherein said label is a laser-printed label.

4. A correlative real-time audio assisted instructional method according to claim 1 wherein said label is printed on said object.

5. A correlative real-time audio assisted instructional method according to claim 1 wherein said label is a sticker.

6. A correlative real-time audio assisted instructional method according to claim 1 wherein said sound information includes name of said object.

7. A correlative real-time audio assisted instructional method according to claim 1 wherein said sound information includes relative information of said object.

8. A correlative real-time audio assisted instructional method according to claim 1 wherein said sound information includes music.

9. A correlative real-time audio assisted instructional method according to claim 1 wherein said sound information includes sound effect.

10. A correlative real-time audio assisted instructional method according to claim 1 further comprises steps for establishing a series of labels correlative to an instructional topic.

11. A correlative real-time audio assisted instructional method according to claim 10 wherein said sound data-base comprises at least:
a question label information table for registering question labels;
an answer label information table, being multiple-to multiple correlative to said question label information table, for registering answer labels;
a description label information table for registering description labels; and
a sound information table for registering said sound information;
data in said sound information table are one-to-one correlative to data of said answer label information table, and one-to-one correlative to data of said description label.
